(19) United States
(12) Patent Application Publication
(10) Pub. No.: US 2012/0030399 A1
(43) Pub. Date: Feb. 2, 2012

(54) MOBILE PHONE DEVICE PLATFORM

(76) Inventor: Almog Ben-Harosh, Pardes Hanna (IL)

(21) Appl. No.: 13/149,642

(22) Filed: May 31, 2011

Related U.S. Application Data
(60) Provisional application No. 61/349,937, filed on May 31, 2010.

(51) Int. Cl. G06F 13/20

(52) U.S. Cl. 710/313

(57) ABSTRACT

Some embodiments relate to an apparatus, method and computer-medium for interacting with a peripheral device (e.g. a mobile phone device) via a USB port. Some embodiments relate to a routine and host device whereby using a technique of function interception, it I possible to intercept the plug-and-play (PnP) handler of the USB hub driver executing on the host device so as to prevent the loading into memory of the host device of a device driver which matches a hardware ID received by the host from a peripheral device. In some embodiments, it is possible to change the received hardware ID to a different hardware ID, and to load, into memory of the host device, a device driver which matches the different hardware ID.

### CROSS-REFERENCE TO RELATED APPLICATIONS

This patent application claims the benefit of U.S. 61/349,937 filed on May 31, 2010 by the present inventor, which is incorporated herein by reference in its entirety.

### BACKGROUND AND RELATED ART

Over the years, for some groups of devices, unified interfaces were established. For example, any off-the-shelf mouse you plug into a computer will function similarly: you don't have to install special word-processing software for each mouse. In contrast, mobile phones do not have similar “standard” interfaces. Partly due to historical lack of leadership, partly due to very differing functionality offered by phone vendors, each phone is represented to the host computer as a different set of interfaces (some standard, some not).

In FIG. 1, the problem is evident: connected a Sony K310 phone results in two “modem” devices and two “port” devices. Connecting a Nokia N95 phone results in a different set of devices: one “modem”, one “portable device”, one “port” device, and two “wireless communications” devices.

Moreover, each phone requires specialized software to manage it: the address-book synchronization software is specialized, the media management software is specialized, etc.

Not only does phone management by a PC require specialized drivers and software, but under the Windows operating system, connecting multiple phones in sequence results in an overload on the system, up to a point requiring rebooting.

In an ideal world, the mobile phone connectivity would be standardized, unified, with a single driver so all application software would be able to manage all mobile phones. The patent described here accomplishes this feat despite the irregularity existing today. The result is shown in FIG. 2, in which a new “mobile phone” device is created per connected device. A much cleaner and simpler view than the previous one, and it allows unified management of either of the phones.

### BRIEF DESCRIPTION OF THE DRAWINGS

FIGS. 1A-1B illustrate the “Mess” caused by connecting either a Sony mobile phone (left) or a Nokia mobile phone (right), without any presently-disclosed apparatus, methods or computer-readable medium.

FIG. 2 illustrates the “unified” device structure with the presently disclosed mobile phone device (MPD) platform, showing two simultaneously connected mobile phones.

FIG. 3 provides a very high-level structure of a MPD system.

FIG. 4 illustrates a SerialUSB smart connector.

FIG. 5 illustrates hardware identity manipulation.

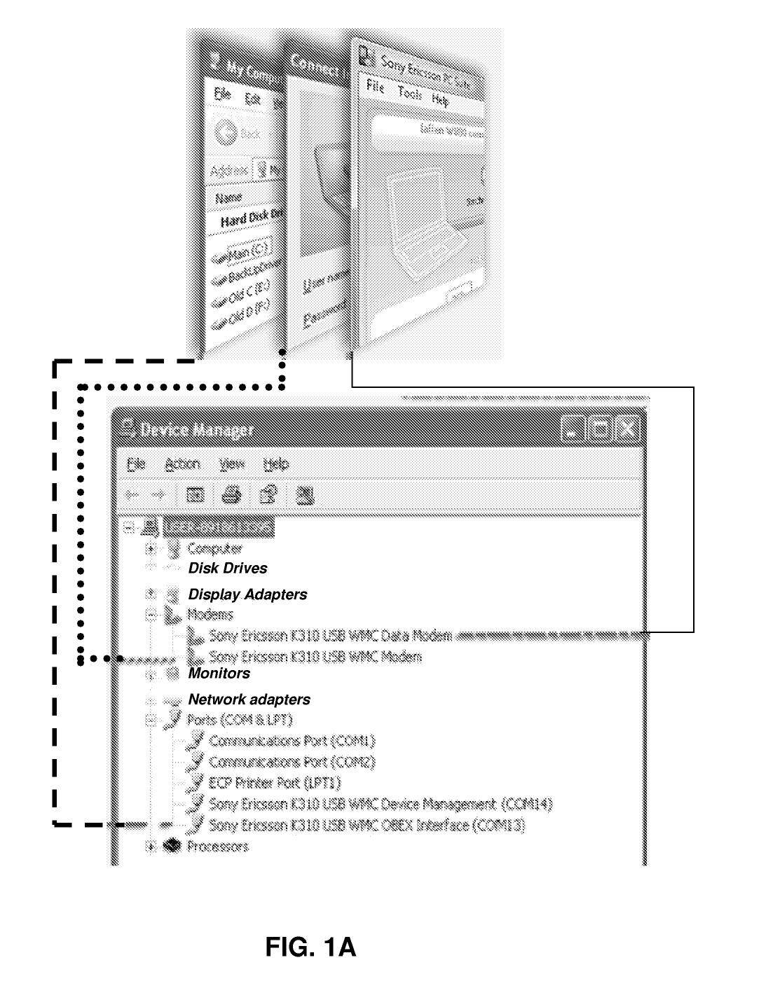

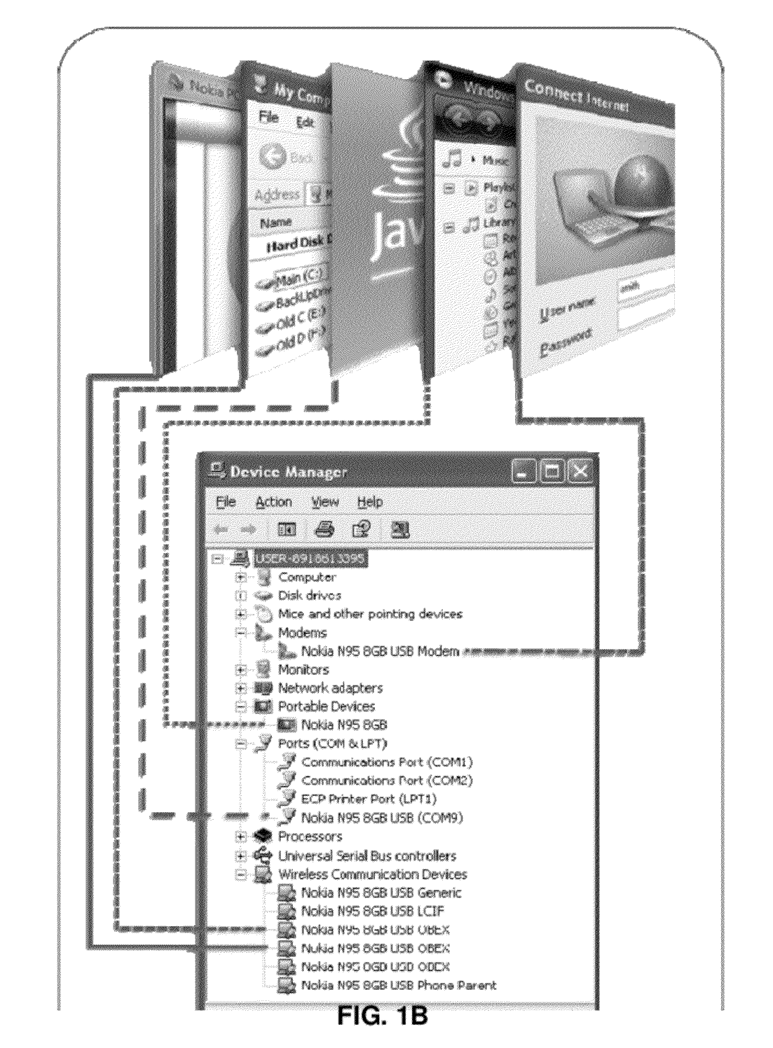

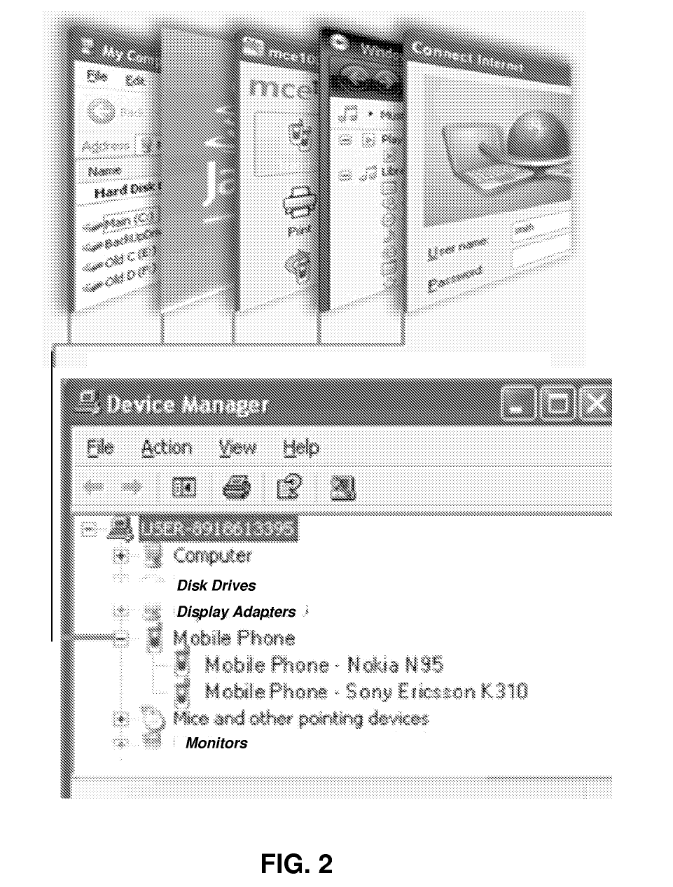

### DETAILED DESCRIPTION OF EMBODIMENTS

Some embodiments of the present invention allow controlled co-existence of the “legacy” system and the new “unified” approach. We (or applications with the decision authority) can choose if to expose only the “legacy” interfaces, only the new unified interface, or some combination, even partial, of the two. This allows smooth migrations and leaves a fall-back to stable, legacy solutions.

Yet another possibility allows is networked management of connected devices. We can create a separation within the infrastructure, in one of several suitable places, allowing a “thin client” to be connected to the device, while the bulk of the processing takes place on a remote server. The local “thin client” may run a minimal MCE driver or no MCE.

For the present disclosure, any “MCE” software driver or system or apparatus refers to a driver or system or apparatus or method

Embodiments of the present invention are relevant t to any group of devices having dissimilar properties, but where some sort of unified API is desired. Mobile phones are one example. Even printers, each with own capabilities, should benefit from this presently-disclosed techniques.

Disclosed embodiments are relevant for the Windows operating system, as well as for the Mac and Linux operating systems, with minor changes to the software.

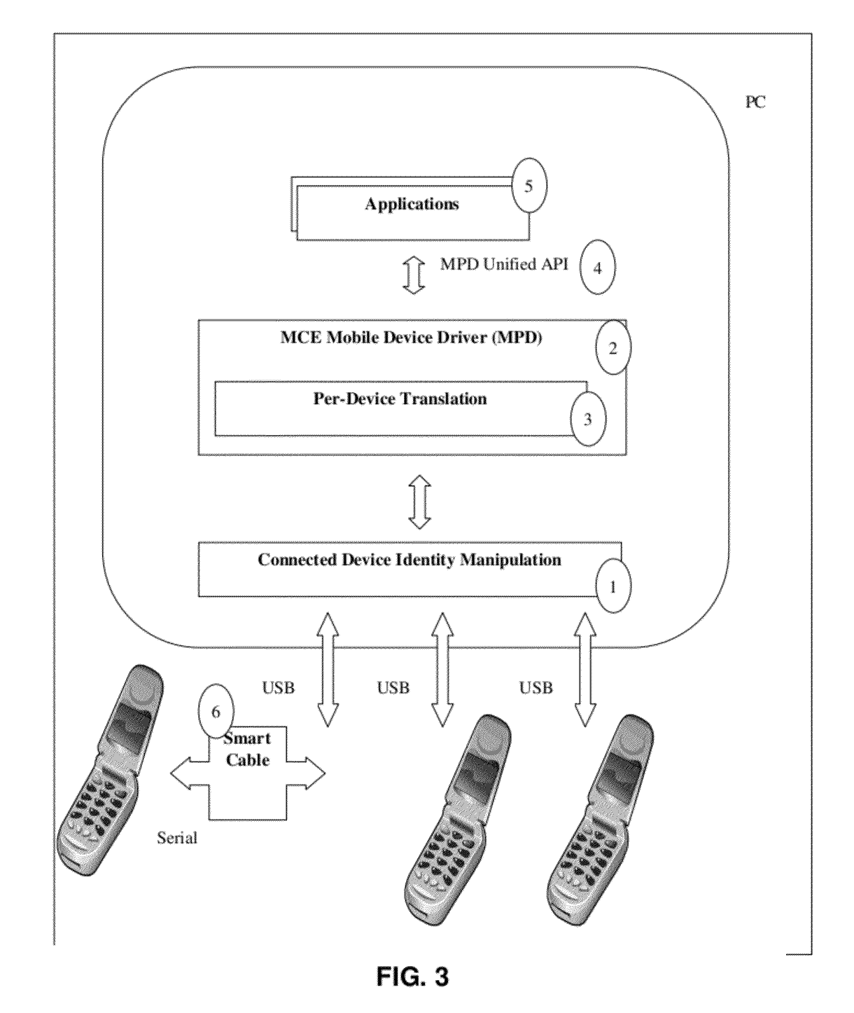

### A Discussion of FIG. 3

FIG. 3 describes a routine comprising 4 stages.

### Stage 1—Physical Connectivity Unification

While the vast majority of mobile phones use USB as a connectivity medium with a PC, some model communicate via serial RS-232, using proprietary connectors and wiring. Some embodiments relate to a set of “Smart Cables” (Block #6) that convert the RS-232 connection to USB connection, while “faking” a USB identity. A synthetic USB code is generated to identify the phone as uniquely as possible to the PC. (Perhaps this stages is entitled a separate patent, we have included it as part of the grand plan. We shall detail it separately from the software modules).

### Stage 2—Interception and Modification of Device Identity

When a hardware device, such as external memory, printer, or mobile phone, is connected to a computer through USB (and also some other methods), the device identifies itself by specific codes, the computer loads device drivers that are registered to handle that hardware.

To load a single, unified driver, we need to trick the system into believing a “unified mobile phone” device (a device class we invented) has been connected. Block #1 takes care of that. MPD can, in real-time, “update” the identity to its original value, resulting to loading of the legacy device drivers for special purposes (e.g. flashing updated software onto the phone).

### Stage 3—Device-Specific Translation

Since each mobile phone is actually different, with unique protocols, capabilities, logic, and data representations, the unification feat is accomplished through an extensive knowledge-base (Block #3) that translates the unified API's commands, queries, and data into the connected phone's native language. Some of the implementation may entitle a separate patent.

### Stage 4—A New Single Unified Device Driver

Instead of the special, numerous, per-phone device drivers, MPD creates and loads a single device driver (Block #2) which communicates with any connected phone, and provides a unified interface (Block #4) for the applications (Block #5), so the application is indifferent an even unaware which mobile phone is connected. The Driver provides high-level functionality using available resource provided by the phone.

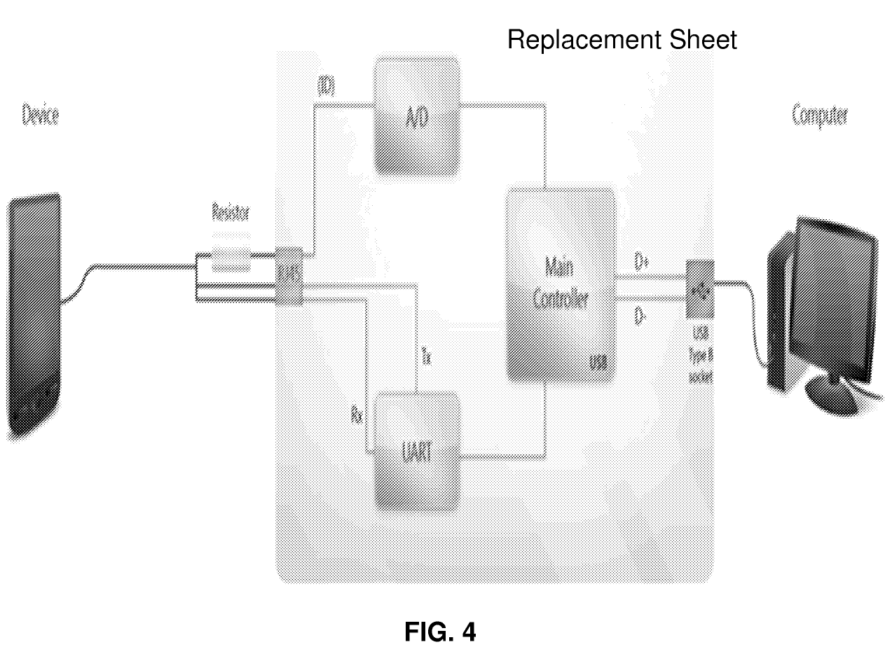

### A Discussion of FIG. 4

Physical Connectivity Unification—RS-232<- ->USB converters aren't new. But our converter also allows identification of the connected device by responding to a specific query from the host, based on a hardware coding of the serial cable.
A “Smart Dongle” design is now disclosed to enable:

USB to Serial RS232 conversion, including:

RS232 control instructions handling

RS232 RX/TX handling

Unique identification for Mobile device HW connector cable.

The main concept of uniquely identifying the connector cable relies on the ability of measuring the resistance of a resistor wired to the cable, using an A-to-D component controlled by the main controller of the dongle, in addition to providing the basic USB Serial functionality.

The Smart Dongle solution includes 2 types of HW components
1. Single USB client dongle
2. Multiple Mobile Device HW connector cables.
FIG. 4 illustrates a Serial<- ->USB smart connector

The system may include some or all of the following components:

A. Mobile Device HW Connector Cable including some or all of:
1. Mobile Device side connector—device specific
2. RS232 connector (RJ 45)

### 3. Wires:

a. RX
b. TX
c. Ground
d. Identification wire with a unique resistance value resistor.
B. USB client dongle (an example) including some or all of:
1. Main controller (CPU+USB Device functionality: detailed below in “USB Descriptor example for Smart Dongle”)
2. A-to-D component
3. UART component
4. USB socket (type B)
5. RS232 socket (RJ 45)
The main controller USB stack implements 3 endpoints:
1. control endpoint (interrupt)
a. RS232 control instructions
b. Connector identification instructions
2. RX endpoint (bulk)
3. TX endpoint (bulk)
Below are some details USB Descriptor according to one non-limiting example implementation of the smart dongle:

Hub Power: Self Power

Number of Ports: 2

Power switching: None

Compound device: No

Over-current Protection: None (Bus Power Only)

Device Descriptor
USB Version: 1.1
Device Class: (0) Reserved (defined in Interface Descriptor)
Device Subclass: 0
Device Protocol: 0
Max Packet Size: 0x40 (64) bytes
Vendor: 0x______ (mce systems, Inc)
Product ID: 0x______
Product Version 0x______
Manufacturer: 1
   0x______: mce systems Inc.
Product: 2
   0x______: USB-Serial Controller
SerialNumber: 0
Number of Configurations: 1

Connection Status Device Connected

Current Configuration: 1

Device Bus Speed: Full

Device Address 0x01

Number of Open Pipes: 3

Configuration Descriptor (1)
Total Length: 39 bytes
Number of Interfaces: 1
Configuration Value: 1
Configuration: 0
Attributes: 0x80
   Bus Powered
Max Power: 0x32 (100 Ma)

Interface Descriptor (0)
Interface Number: 0
Alternate Setting 0x00
Number of Endpoints: 0x03
Interface Class: (255) Vendor Specific
Interface Subclass: 0
Interface Protocol: 0
Interface: 0

Endpoint Descriptor (Addr: 0x81)
Endpoint Address: 0x81, Input
Transfer Type Interrupt
Max Packet Size: 0x000a (10) bytes
Interval: 0x01

Endpoint Descriptor (Addr: 0x02)
Endpoint Address: 0x02, Output
Transfer Type Bulk
Max Packet Size: 0x0040 (64) bytes
Interval: 0x00

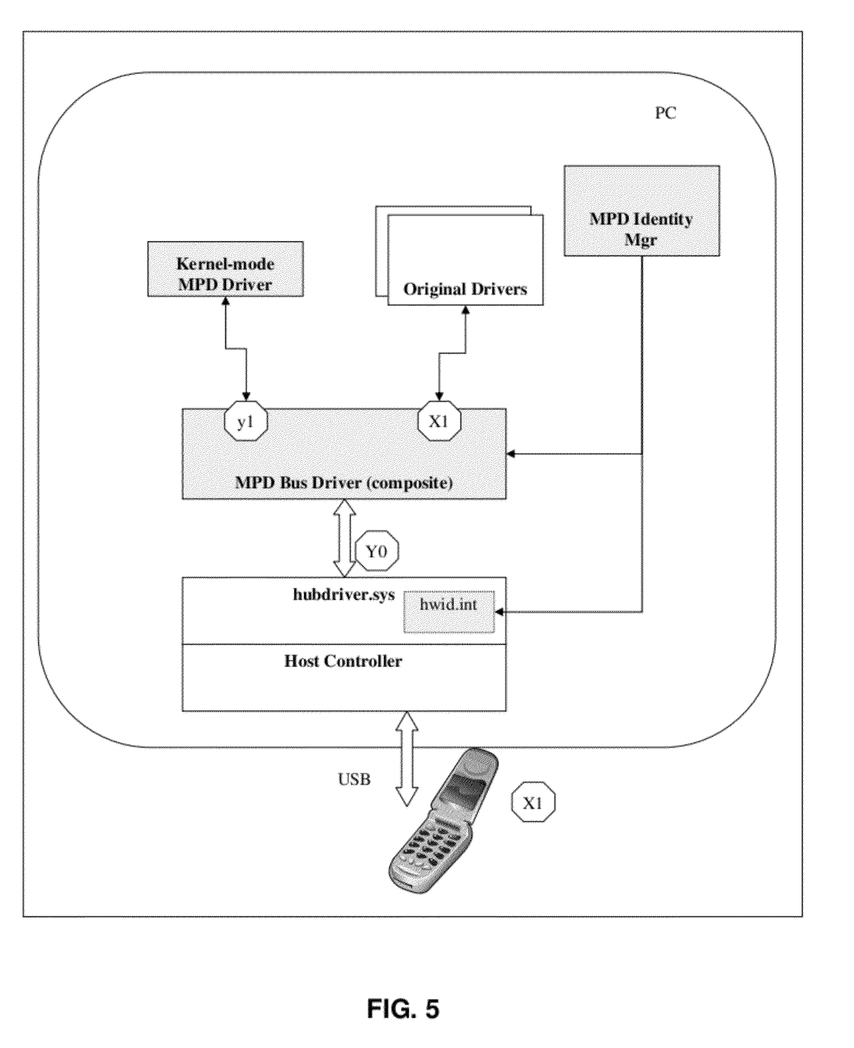

Endpoint Descriptor (Addr: 0x83)
Endpoint Address: 0x83, Input
Transfer Type Bulk
Max Packet Size: 0x0040 (64) bytes
Interval: 0x00
   A Discussion of Interception and Modification of Device Identity with Reference to FIG. 5

Below is one possible implementation of device identity manipulation. It involves the components as shown in FIG. 5, which exist in various operating systems, such as Windows, Linux, MAC OS:

a. Modifying the Device Identity from within the Hub Driver.

Each USB hardware is represented by a hub driver. It is a mutual attribute of Windows, Linux and Mac OS. The hub driver passes through the hardware identifiers associated with the USB. The original ID is depicted as “X1” in FIG. 5 below.

Using a technique of kernel-mode interrupt interception, we intercept the PnP handler of usbhub.sys, the hub driver. We look for IRP_MN_QUERY_ID (function drivers and filter drivers do not handle this IRP), we change the hardware ID to our own special ID, depicted as “Y0”. We also listen to IRP_MN_QUERY_CAPABILITIES, to disable the flag “unique” so single mpdbus.sys will be loaded even if phones are changed. Another method to perform this identity modification can be achieved by replacing altogether the hub driver. We believe the former approach is more robust and requires less interference with the system.

The operating system is instructed to load our own Composite Bus Driver, mpdbus.sys, when the ID “Y0” is encountered.

b. MPD's Composite Bus Driver

A composite bus driver natural task is dynamic loading and unloading of various devices per connected hardware. Since MPD's bus driver was loaded, due to the change of hardware ID, we can manipulate the behavior of the bus driver to do the following:

1. Announce the existence of the original hardware, “X1”, which will cause the loading of the original bus driver and all subsequent original drivers. In this case, the bus driver will function as “pass through”, it will be as if MCE-SYS's drivers are not installed.
2. Announce the existence of MPD's special hardware, “Y1”, which will load MPD's Phone Driver. No original drivers will load.
3. A combination of the two above. For example, the original device may expose several interfaces, such as MSD and MODEM. We can choose to expose only MODEM in addition to MPD's Phone Driver.
c. Kernel-Mode MPD Driver

### Generic;

Single instance per physically connected device of type “Y1” (in the case of mobile phones);
Thin kernel-mode layer (most logic in user-mode layer).
d. Identity Manager

The decision which devices or interfaces to expose can be dynamically controlled through the Identity Manager. The Identity Manager can be accessed from applicative layers. For example, a security policy may require disabling all MSD interfaces, or a special software update utility may require temporary use of original drivers.

### Device-Specific Translation

### The “Profile” Concept

A Profile is a collection of all the information required for successful management of the connected device. For mobile phones, it may include: USB endpoints, data formats, data structures, protocols, etc.

This knowledge may be available through prior investigation of the phone, or through run-time investigation, or some combination thereof.

The following software components are used to implement the aspects of the profile.

### The “Connection” Concept

A representation of a physically connected device.

### Port Component Interface

The low-level communication with connected devices is often based on one or more of several known interfaces (some phone-related examples include: CDC-ACM (MODEM/Virual Comm-port), CDC-ECM (network interface), MTP, WMCDC, MSD), and vendor-proprietary (e.g Blackberry's, Motorola's).

The services provided by these interfaces are unified by our “Port Component” into a simple, generic interface with the following API:

Open

Close

Read

Write

IO Control

The Port Component implements internally all the required logic to actually communicate with the connected devices. It uses a “connection” as logical address of the device.

### Protocol Interface (Aka “Folder”)

Folder is an abstraction of a list of items of a specific type (with mobile phones, examples include: SMS received, SMS sent, contacts). Its API includes, among others, the following actions:

Open/Close

Find First item (with optional filter)

Find Next item

Read/Write/Delete/Create content item

Folder Value Get/Set/IO Control

Register Notification

The Protocol actions use the Port Component Interface. It implements internally the appropriate communication protocol stack (such as OBEX, SyncML, AT-Commands, Qualcomm-BREW) for implementing the general folder functionality.

### Format Filter

The Format Filter converts data types from various (sometimes proprietary) formats to other formats. In the mobile phone domain, for example, contacts are usually stored in the VCard format, but there are some private variations.

The Format Filter API includes, among others:

Set/Query parameters

Conversion IO Control (from, to)

### Structure Adaptor

This is a helper service for structural conversion between folders. For example, converting change-based folders to content-based folders, creating change folder from two content folders, or flattening tree-structured folders to one big folder. Its API is identical to that of the Protocol Interface.

### Mobile Service

Represents a general collection of data relevant to sessions involving mobile phone(s), such as ESN, software versions etc. The data is collected in the appropriate manner from the specific devices connected.

The API's important functions include:

Get/Set value

### Recognizer

A component that helps a new connection establish the identity of the connected device. It interrogates the connection for some attributes that allows consulting the device profile database to identify the connected device.

### Knowledge-Base (Profile Collection)

A collection of per-device information. It is used to identify the mobile phone and to communicate with it in its specific “language”. The various modules listed above use the information from this knowledge base to interact in the right protocols, using the correct data types.

### New Single Unified API

### The “Session” Concept

The interaction with a profile (specific phone) over a “connection” (specific physical port).

### Content Type Manager

The top-level manager implementing the “Session” of the Mobile Phone API. It creates other objects based on the specific device connected.

### Mobile Phone API

Creation of sessions and management of mobile phones is done via new, general API. It may provide support or implement some or all of the following functions:

### General:

MobilePhoneAPIStartupA

MobilePhoneAPIStartupW

MobilePhoneAPICleanup

### Profile Functions:

MobilePhoneProfileFindFirst

MobilePhoneProfileFindNext

MobilePhoneProfileFree

MobilePhoneProfileFindClose

MobilePhoneProfileQueryValueA

MobilePhoneProfileQueryValueW

### Connection Functions:

MobilePhoneConnectionFindFirst

MobilePhoneConnectionFindNext

MobilePhoneConnectionFree

MobilePhoneConnectionFindClose

MobilePhoneConnectionQueryValueA

MobilePhoneConnectionQueryValueW

MobilePhoneConnectionNotifyChange

MobilePhoneConnectionCancelNotifyChange

MobilePhoneConnectionGetSupportedProfiles

MobilePhoneConnectionFreeSupportedProfiles

### Session Functions:

MobilePhoneSessionCreate

MobilePhoneSessionDestroy

MobilePhoneSessionQueryValueA

MobilePhoneSessionQueryValueW

MobilePhoneSessionSetValueA

MobilePhoneSessionSetValueW

MobilePhoneSessionOpenIOFolderA

MobilePhoneSessionOpenIOFolderW

MobilePhoneSessionCloseIOFolder

MobilePhoneSessionIOFolderQueryValueA

MobilePhoneSessionIOFolderQueryValueW

MobilePhoneSessionIOFolderSetValueA

MobilePhoneSessionIOFolderSetValueW

MobilePhoneSessionIOControl

MobilePhoneSessionFilterIOControl

MobilePhoneSessionIOListingFirst

MobilePhoneSessionIOListingNext

MobilePhoneSessionIOItemFree

MobilePhoneSessionIOItemRead

MobilePhoneSessionIOItemCreate

MobilePhoneSessionIOItemWrite

MobilePhoneSessionIOItemDelete

MobilePhoneSessionIOItemQueryValueA

MobilePhoneSessionIOItemQueryValueW

MobilePhoneSessionIOItemSetValueA

MobilePhoneSessionIOItemSetValueW

MobilePhoneSessionRegisterNotification

MobilePhoneSessionUnregisterNotification

### Additional APIs

On top of the Mobile Phone API we can implement standard services like MTP, RAPI etc.

1. A method of operating a host device coupled to a USB peripheral device via a USB port, the method comprising:
a. at the host device, receiving via the USB port a hardware ID of the coupled USB peripheral device, from the coupled USB peripheral device;
b. using a technique of function interception, intercepting the plug-and-play (PnP) handler of the USB hub driver executing on the host device so as to prevent the loading of a device driver which matches the received hardware ID from being loaded into memory of the host device,
c. changing the received hardware ID to a different hardware ID, and
d. loading, into memory of the host device, a device driver which matches the different hardware ID.
